(19) United States
(12) Patent Application Publication
(10) Pub. No.: US 2017/0237388 A1
(43) Pub. Date: Aug. 17, 2017

(54) MODULAR ROOF MOUNTING SYSTEM FOR PHOTOVOLTAIC PANELS

(71) Applicant: SUNLINK CORPORATION, Mill Valley, CA (US)

(72) Inventors: Miguel M.L. Praca, Kentfield, CA (US); Yury Reznikov, Danville, CA (US); Joost Richard de Wilde, Castro Valley, CA (US)

(21) Appl. No.: 15/583,607

(22) Filed: May 1, 2017

Related U.S. Application Data
(62) Division of application No. 14/746,713, filed on Jun. 22, 2015, now abandoned.
(60) Provisional application No. 62/015,998, filed on Jun. 23, 2014.

(51) Int. Cl. H02S 20/23; F24J 2/52; F16B 5/06

(52) U.S. Cl. CPC H02S 20/23; F16B 5/0685; F24J 2/5256; F24J 2/5205; F24J 2002/5281

(57) ABSTRACT

A Modular Roof Mounting System utilizes an assembly Jig that makes assembly of the structural units very easy and repeatable. The assembly Jig incorporates a photovoltaic panel mounting frame that the structure is required to support. In addition to the photovoltaic panel mounting frame it includes only two low cost universal components: two South rail locators and two North rail locators. The North and South rail locators are attached to the mounting holes in the panel frame, two on the South edge and two on the North, and produce a rail spacing that lines up with the same holes. The North Rail Locators have additional locating features to position the cross beams. Using a photovoltaic panel mounting frame to create a Jig that automatically determines the configuration of the Precision-Modular assembly and requires no adjustments and allows for the assembly of mounting structures for various photovoltaic panel geometries.

This application claims the benefit of U.S. Provisional Application No. 62/015,998, filed Jun. 23, 2014, entitled MODULAR ROOF MOUNTING SYSTEM, the disclosure of which is herein incorporated by reference.

### BACKGROUND OF THE INVENTION

1. Field of the Invention

The present invention relates generally to a photovoltaic panel mounting, systems, and more particularly to a modular roof mounting system for photovoltaic panels.

2. Description of the Related Art

One challenge in the design of a universal photovoltaic module mounting system is the wide range of variation in module sizes and mounting geometries. The ideal solution would be a standard kit that works with any type of solar module, but given the wide variation in module geometry it is hard to make such a universal solution work without other costly compromises. This is particularly difficult when the mounting system is a contiguous structure rather than a series of elements that rely on the solar module frame to provide physical continuity across the array.

### SUMMARY OF THE INVENTION

In general, the present invention is a universal photovoltaic module mounting system. The Precision-Modular Roof Mounting System (RMS) according the present invention is a system that is able to achieve a contiguous structure without sacrificing its universality across a wide range of module geometries. Most components incorporated in the Precision-Modular RMS are universal, accommodating all module sizes, with varying geometries.

More particularly, according to an embodiment of the present invention, the Precision-Modular Roof Mounting System utilizes an assembly Jig that makes assembly of the structural units very easy and repeatable. One unique aspect of the Jig design is that it does not require any adjustments or measurements as it is built to the correct geometry. It accomplishes this by integrating a photovoltaic panel mounting frame that the structure is required to support. In addition to the photovoltaic panel mounting frame it includes only two low cost universal components.

Specifically, the assembly Jig according to an embodiment of the present invention includes two South rail locators and two North rail locators, which are mounted on the photovoltaic panel mounting frame that has been chosen for a particular project. The rail locators are attached to the mounting holes in the photovoltaic panel mounting frame, two on the South edge and two on the North, and produce a rail spacing that lines up with the same holes. The North Rail Locators have additional locating features to position the cross beams. There may be multiple locating features to accommodate different size ballast blocks or a different number of rows of ballast. Using a photovoltaic panel mounting frame to create a Jig that automatically determines the configuration of the Precision-Modular Roof Mounting System and requires no adjustments provides a significant improvement over current mounting structures and methods.

According to one embodiment of the present invention, a modular photovoltaic panel mounting system utilizes an assembly Jig comprising a photovoltaic panel mounting frame, first and second North rail locators attached to a first side of the photovoltaic panel mounting frame, and first and second South rail locators attached to a second side of the photovoltaic panel mounting frame, the second side opposite the first side. The mounting system further comprises a first rail positioned at the first North rail locator and the first South rail locator, a second rail positioned at the second North rail and the second South rail locator, wherein the second rail is located parallel to the first rail, a first cross beam attached perpendicular to the first and second rails, a second cross beam attached perpendicular to the first and second rails, and parallel to the first cross beam, a first strut clamp attached to the first rail, and a second strut clamp attached to the second rail, wherein the assembly Jig facilitates the location and alignment of the first and second rails, the first and second cross beams, and first and second struts.

A method according to the present invention includes a method of constructing an assembly Jig comprising the steps of:

placing a mounting frame of a photovoltaic panel to be mounted in a mounting location;

attaching first and second North rail locators to mounting holes on a first side of the photovoltaic panel frame;

attaching first and second South rail locators to mounting holes on a second side of the photovoltaic panel frame, the mounting frame, and rail locators comprising an assembly Jig.

The Jig is then used to construct multiple Precision-Modular assemblies, identically configured, the construction steps comprising:

positioning a first rail in the first North and first South rail locators;

positioning a second rail in the second North and second South rail locators;

positioning a first cross beam in the first and second North rail locators, perpendicular to the first and second rails;

positioning a second cross beam in the first and second North rail locators, the second cross beam parallel to the first cross beam, and perpendicular to the first and second rails;

positioning a first North strut on the first rail and engaging the first cross beam;

positioning a second North strut on the second rail and engaging the first cross beam;

attaching the second cross beam to the first and second rails;

attaching the first cross beam and the first North strut to the first rail; and

attaching the first cross beam and the second North strut to the second rail.

Once the structure is assembled, the mounting structure is removed from the assembly Jig. This process may be repeated to produce as many Precision-Modular assemblies as required to build a particular array.

As the Precision-Modular assemblies are built, they can be laid out in any two-dimensional array format required, interlocking mechanically in both directions. In the North-South direction a rail link extending from the North end of an assembly engages the South end of a next assembly, inserting into the rail track and registering on the tabs of the rail link. In the East-West direction, a Stiffener of one assembly fastens onto a Stiffener of a next assembly with two bolt-nut pairs. Multiple fastening locations may be available on the Stiffener to accommodate more than one possible spacing between assemblies,

Ballast blocks may be placed on the array, and the blocks are supported between the two cross beams of each assembly.

Finally, the photovoltaic panels are mounted onto the array in two steps. First, the module mounting clips are attached to both holes on a first side of each photovoltaic module. Then the modules are mounted to each Precision-Modular assembly in the array, fastened on the South side via the module mounting clips, and engaging on the North side hooks on a module flange on both North struts. Once all the modules are mounted and fastened, the system is mechanically complete.

### BRIEF DESCRIPTION OF THE DRAWINGS

The present invention will be readily understood by the following detailed description in conjunction with the accompanying drawings, wherein like reference numerals designate like structural elements, and in which:

FIG. 1 illustrates an assembly Jig according to an embodiment of the present invention;

FIG. 2 illustrates mounting rails placed in the Jig of FIG. 1;

FIG. 3 further illustrates the assembly of cross-beams and strut clamps;

FIG. 4 illustrates a rail link used to connect two rails together, according to an embodiment of the invention;

FIG. 5 illustrates the attachment of a Stiffener to the mounting assembly;

FIG. 6 is a detailed view of a Stiffener element, according to an embodiment of the invention;

FIG. 7 shows a 4×4 array of modular mounting assemblies according to an embodiment of the present invention;

FIG. 8 illustrates the attachment of components of the mounting system, according to an embodiment of the present invention;

FIG. 9 illustrates an array including ballast blocks, according to an aspect of the present invention;

FIG. 10 illustrates a photovoltaic module with mounting clips, according to an embodiment of the present invention;

FIG. 11 illustrates the alignment of the module and mounting clips of FIG. 11 on a rail, according to an embodiment of the present invention;

FIG. 12 illustrates a module engaging an attachment hook of a strut clamp, according to an embodiment of the present invention;

FIG. 13 illustrates a cover added to the mounting system;

FIG. 14 shows feet added to a rail, according to an aspect of the present invention;

FIG. 15 illustrates the wiring routing and connections along a Stiffener, according to an embodiment of the present invention:

FIG, 16 illustrates the rail link of FIG. 4 in further detail;

FIG. 17 illustrates the attachment of the struts and cross beams in further detail;

FIG. 18 illustrates an additional view of the struts and cross beam attachments of FIG. 17; and

FIG. 19 illustrates the cover of FIG. 13 in further detail.

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art. Any and all such modifications, equivalents and alternatives are intended to fall within the spirit and scope of the present invention.

As described above, it is desired to have a More; universal photovoltaic module mounting system. The Precision-Modular Roof Mounting System (RMS) according the present invention is a system that is able to achieve a contiguous structure without sacrificing its universality across a wide range of module geometries. Most components incorporated in the Precision-Modular RMS are universal, accommodating all module sizes, but it is practical to deviate slightly from absolute universality by dividing the solar module (also referred to as a photovoltaic panel or solar panel) universe into a few subsets within which the range of variation is considerably smaller.

One practical way to divide the universe of solar modules is based on the number of solar cells per module, since the number and arrangement of the cells correlate closely with the geometry of the module. Typical module categories are 60-cell, 72-cell, and 96-cell modules. Each category may have a wide variation of mounting geometries. Generally modules have four, six, or eight mounting holes provided, of which four are generally required for the most common loading conditions.

The Precision-Modular RMS of the present invention has been designed to accommodate all modules that fall into any defined category with a fixed set of components, using a four-hole mounting pattern. In general, the Precision-Modular RMS system according to an embodiment of the present invention includes a fixed set of components, and can be configured to match, any particular module within any given category.

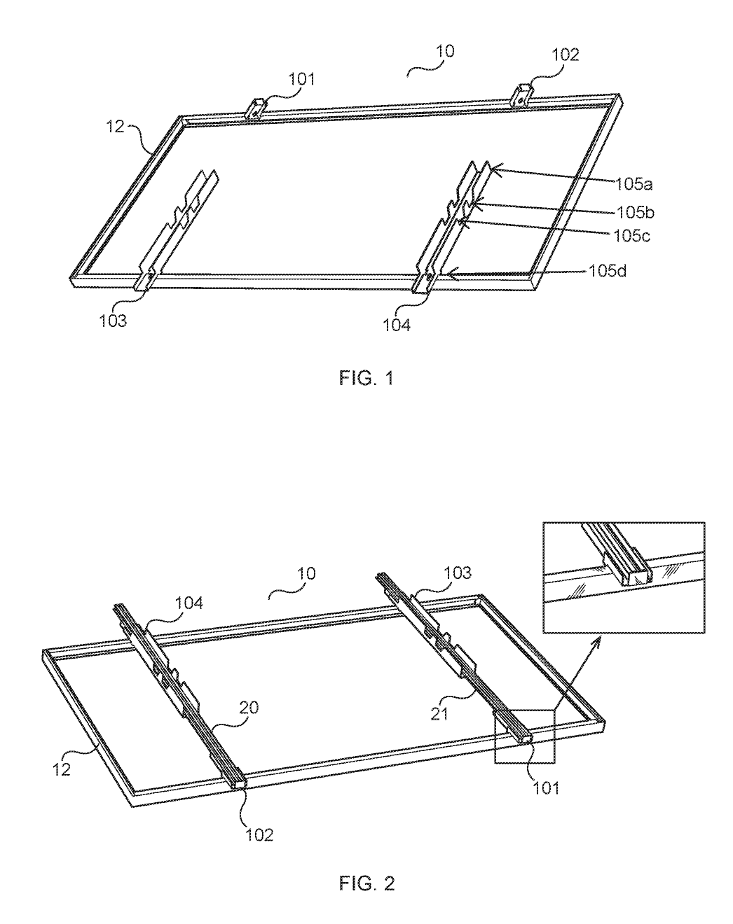

More particularly, as illustrated in FIG. 1, the Precision-Modular Roof Mounting System according to an embodiment of the present invention relies on a Jig 10 that makes assembly of the structural units very easy and repeatable. One unique aspect of the Jig 10 design is that it does not require any adjustments or measurements, as it is built to the correct geometry. It accomplishes this by integrating the photovoltaic panel mounting frame 12 that the structure is required to support. In addition to the photovoltaic panel mounting frame 12, it includes only two low cost universal components.

Specifically, the Precision-Modular assembly Jig 10 according to an embodiment of the present invention includes two South rail locators 101, 102 and two North rail locators 103, 104, which are mounted on the photovoltaic panel mounting frame 12 that has been chosen for a particular project. The rail locators 101-104 are attached to the mounting holes in the panel mounting frame, two on the South edge and two on the North, and produce a rail spacing that lines up with the same holes. The North Rail Locators 103, 104 have additional locating features 105a-105d to position the cross beams. The South Rail locators 101, 102 determine the longitudinal position of the rails by providing a rail end registration.

There may be multiple locating features 105a-105d to accommodate different size ballast blocks or a different number of rows of ballast. The ballast is supported by the cross beams, and therefore the cross beams' spacing is determined by the size and orientation of the ballast blocks that are selected, depending on availability and cost.

Using, a photovoltaic panel mounting frame 12 to create a Jig 10 that automatically determines the configuration of the Precision-Modular assembly and requires no adjustments provides a significant improvement over current mounting structures and methods. The built-in accommodation for different size ballast blocks without any adjustment is an additional advantage of this design.

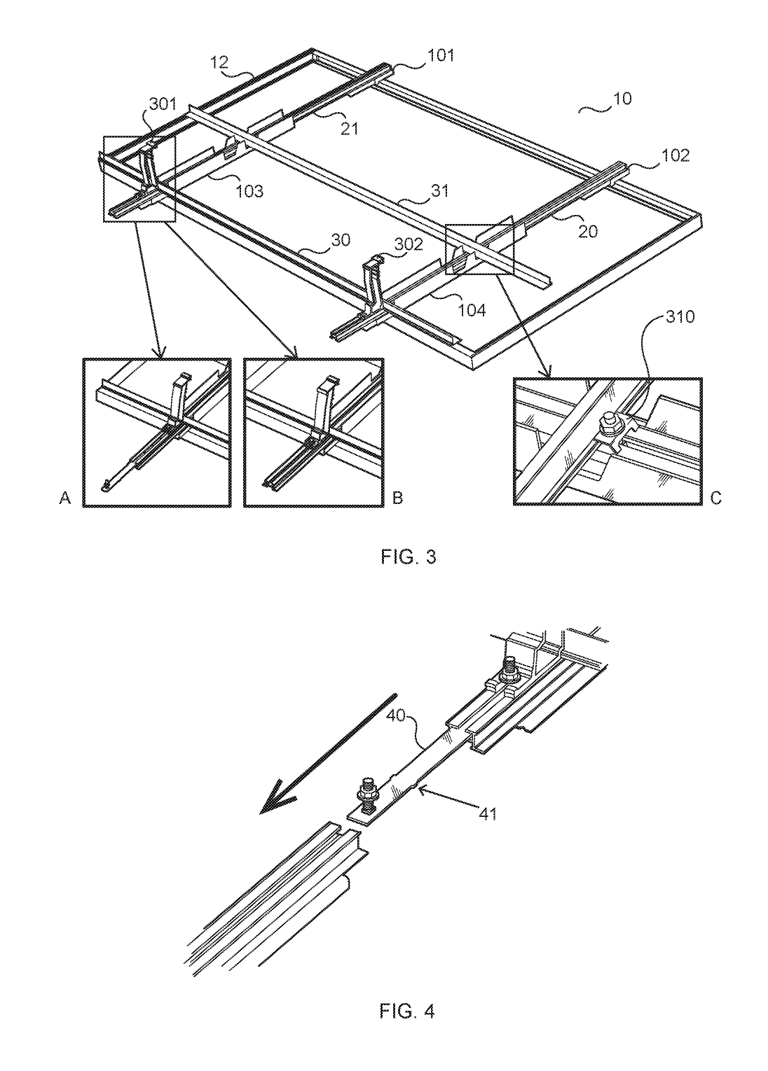

The present invention includes a method for using the Jig 10 to assemble the Precision-Modular system. The method includes the following steps. First, the rails may have elastomer “feet” (see FIG. 12) snapped to the underside of each rail. If the feet are wider than the rail, the channel of the Jig 10 locators are designed to register on the width of the feet rather than the width of the rails. Each rail preferably gets one foot placed approximately 1 inch from the south end of the rail, and a second foot placed approximately 6 inches from the north end of the rail, or sufficiently far from the end of the rail to sit in the channel of the North Jig locator. As illustrated in FIG. 2, the rails 20, 21 are placed on the Jig 10 and registering each rail edge against the South Rail Locators 101, 102. Next, as illustrated in FIG. 3, cross beams 30, 31 are placed across the rails 20, 21, visually centered, and located in the North-South direction by registering on the cross-beam locators 105a-105d.

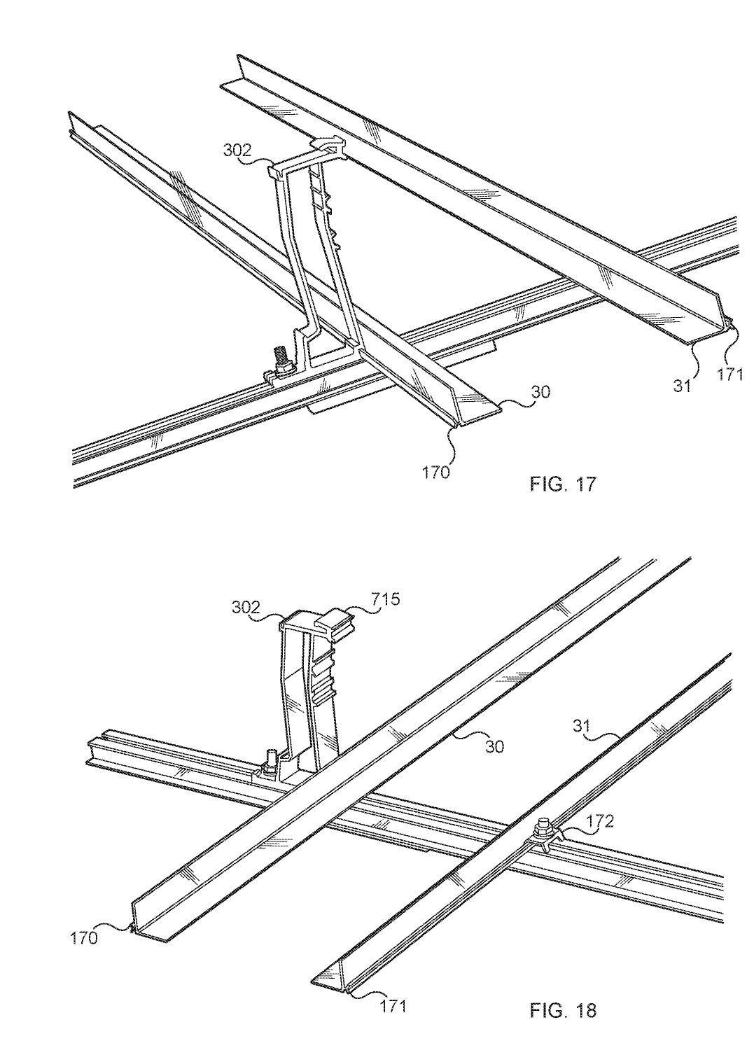

The first cross-beam 30 is clamped in place by the North struts 301, 302, which use a carriage bolt and nut to fasten to the rails. The North struts clamp and secure the cross beam by engaging into a “track” formed on the front of the cross beam (FIGS. 17-18). Unless it is the North row of an array, the same bolt engages the rail link on one of multiple possible positions—as described below. The second cross beam 31 is clamped to the rail using a clip 310 that is fastened with a bolt and nut (as shown in enlargement C). The clamp engages and secures the cross beam on the track along the front of the beam, in a similar fashion as the North strut.

The bolt used on both the North struts 301, 302 and the clip 310 is a carriage bolt that engages a track on the rail. A different type of bolt, such as a hex-head bolt, can also be used, with a matching track profile that would allow the bolt to move longitudinally but prevents its rotation. As shown in enlargement A, a rail link may be attached to the end of a rail in order to attach the rail to a rail in a next assembly, to form an array.

As illustrated in FIG. 4, another set of the same bolt-nut pair is preassembled on the end of a rail link 40 which will be inserted on the track of the next Precision-Modular structure, where it will be used to fasten the south side of the adjacent solar module. The rail link 40 has a “tab” feature 41 located on each edge that will register on the next rail locating its correct position, and requiring no adjustments or measurements to space the structures correctly.

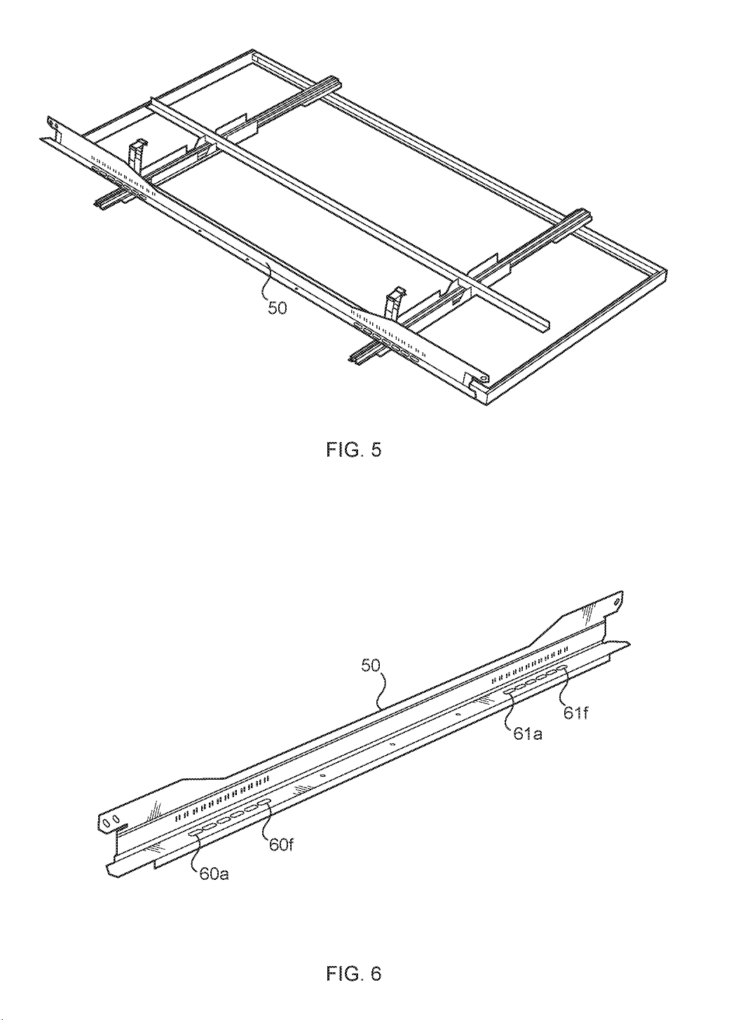

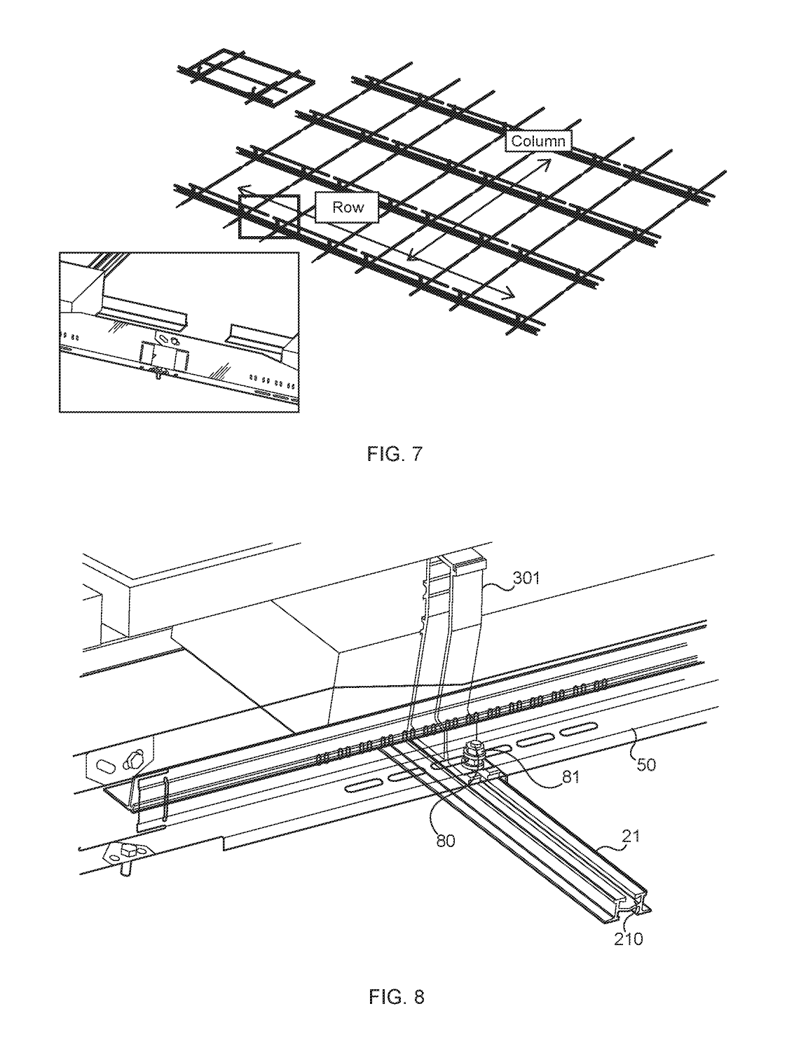

As shown in FIG. 5, an additional component may be added, a Stiffener 50, which adds structural rigidity in the East-West direction and provides for fastening of Precision-Modular structures in that direction. FIG. 6 illustrates a preferred embodiment of the Stiffener 50. The Stiffener 50 is configured to interface with the rails, and has multiple attachment slots 60a-60f and 61a-61f, to facilitate mounting on many different geometries. The Precision-Modular RMS assemblies can therefore form a chain to mount as many modules as required, creating what is called a column (North-South sequence of modules), without requiring any measurements or adjustments. And multiple columns, interlocking with the Stiffeners 50, can form a two-dimensional array, as shown in FIG. 7, constrained in both directions, with no need for adjustment or alignment.

Each time a Precision-Modular assembly is completed, it is removed from the Jig 10, which is then used for the next assembly, in succession. As a result, a mounting array of identical assemblies is formed with the exact dimensions necessary for mounting photovoltaic panels, having frames identical to the one used to construct the Jig 10.

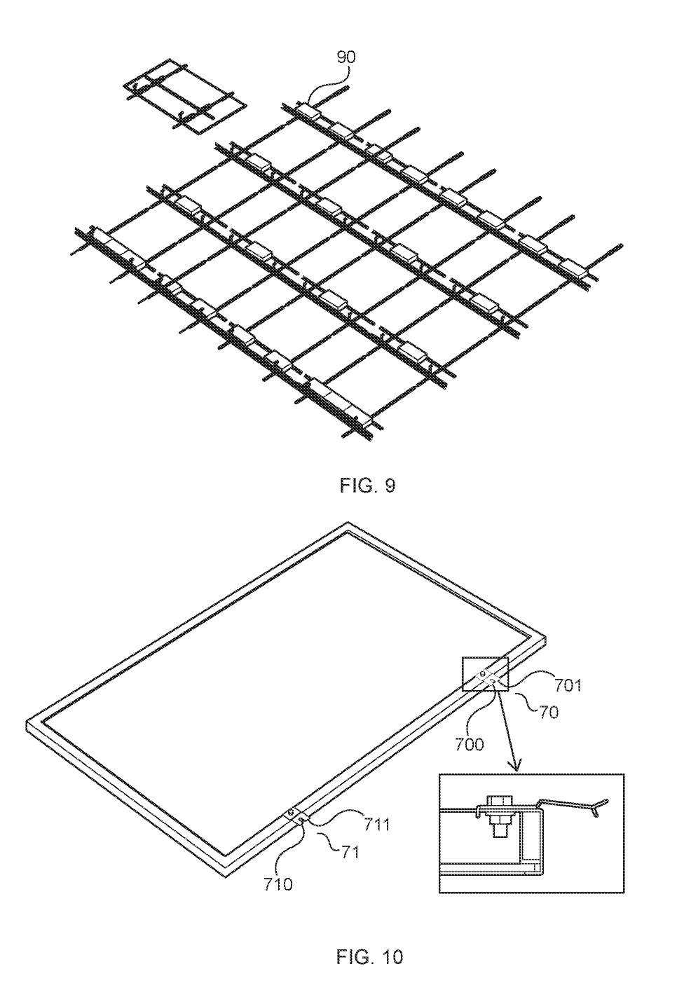

As illustrated in FIG. 8, a second nut 81 is used on each bolt 80 to fasten the Stiffener 50. This single bolt 80 ties together five components: the Rail 21, Rail Link (not shown; see FIG. 4), Cross Beam 30, North Strut 301, and Stiffener 50. The rails comprise a channel 210 on a top side, wherein the channel 210 is configured to allow a bolt head on the bolt 80 to slide along the channel 210, which allows variable positioning of the cross beams and struts. This economy of fasteners and fastening operations reduces hardware and labor costs, and is an improvement over prior mounting configurations. The vertical positioning of all bolts in the system allows for easy assembly and torqueing of the fasteners since the components are aligned in place and immobilized before the final nut is added. The fastening of a four sided structure, having as many as nine components, in the shape of a geometrically configurable rectangle to mount a specific photovoltaic panel with only four bolts represents a significant improvement over prior systems.

The Stiffener 50 is designed to provide more than a single column width, so it can accommodate a wider range of module sizes without necessarily resulting in a large gap in the case of smaller size photovoltaic modules. The contiguous Stiffeners are interlocked and fastened with two bolt/nut pairs.

The arrays are therefore built by laying out the modular assemblies, interlocked and fastened in both orthogonal directions. This method to replicate Precision-Modular assemblies can be used to build continuous, interlocked and evenly spaced rows creating a two-dimensional array.

Once the array or multiple arrays are assembled, ballast 90 may be placed over the cross beams, as illustrated in FIG. 9. FIG. 9 shows pavers in a single row per module. However, as many as two rows of multiple pavers can be placed on the cross-beams depending on paver size and module size.

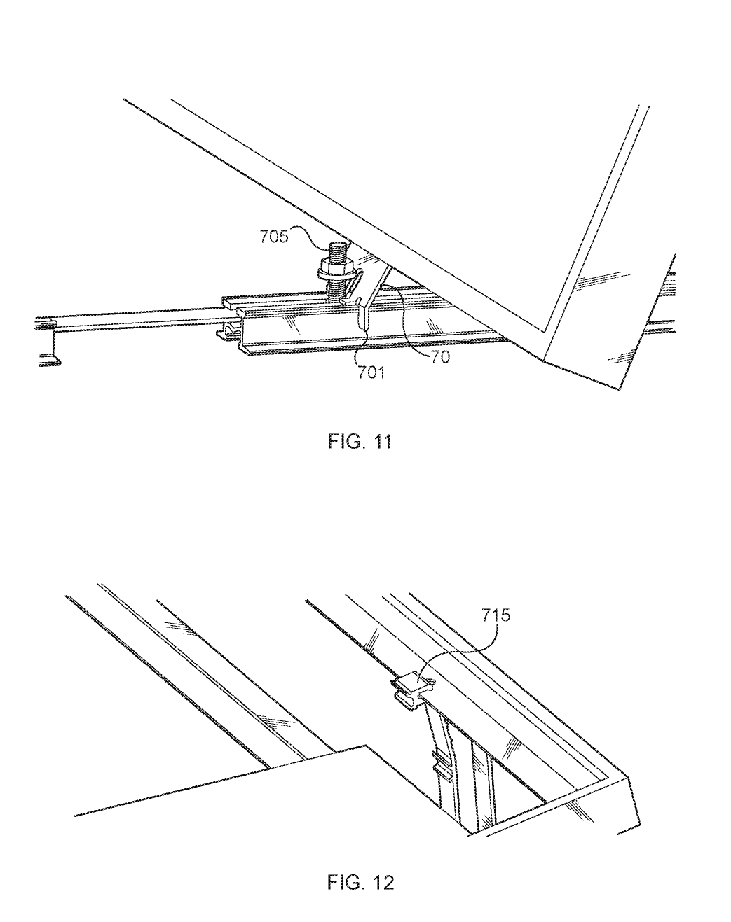

Once the Precision-Modular assemblies are constructed, the system is ready to receive the photovoltaic modules, which are first preassembled with two South Clips 70, 71 as shown in FIG. 10. The South Clips 70, 71 are assembled to the module at the mounting holes so that their spacing matches the rail spacing determined by the Jig 10. The South Clips 70, 71 have two guiding tabs 700, 701 and 710, 711, respectively, that straddle the rails and help align the module to the rails during installation. This is illustrated in greater detail in FIG. 11. The rail links have already set the bolts in their correct location, so the module can be positioned with the South Clips 70, 71 up against the bolt and then rotated down to rest on the North Struts. By sliding the module back, the flange on the North side engages hooks 715 on the North Struts (FIG. 12) and the slot on each South Clip 70, 71 engages a bolt 705 that is then fastened firmly. This secures the module with a four-point support configuration.

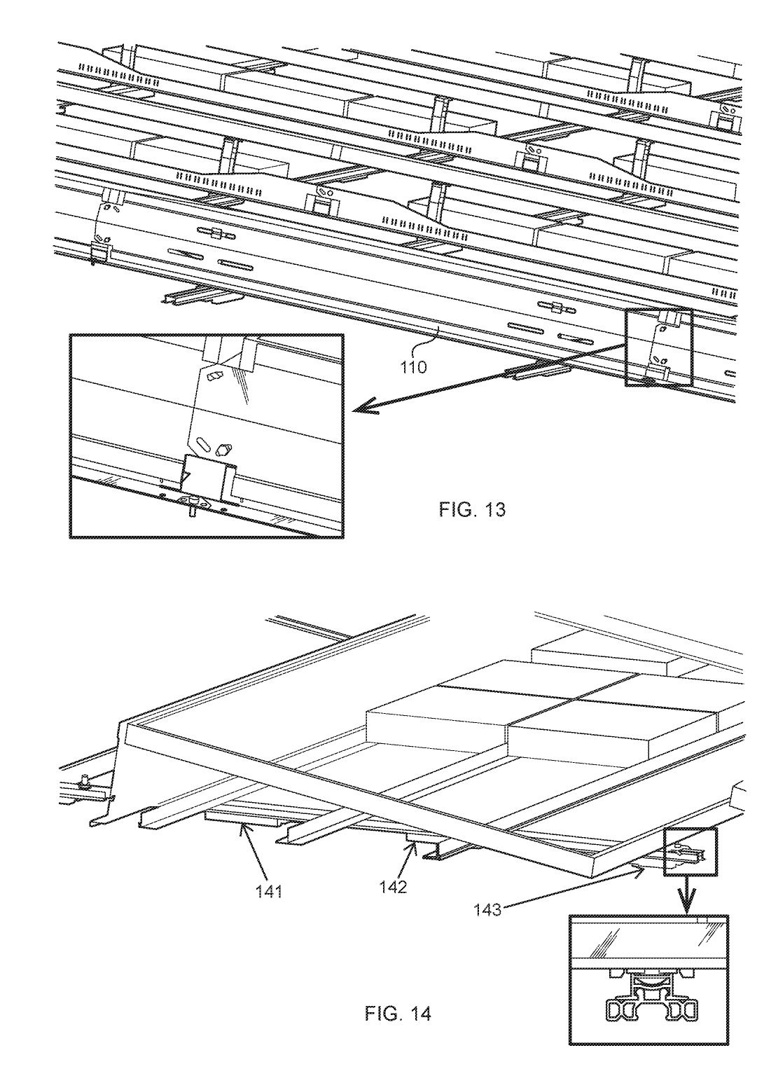

As shown in FIG. 13, after attaching the modules, some modules (generally the North row) may have a cover 110 fastened over the Stiffener 50, to create a wind is deflector. The cover 110 has slots that engage on a small hook in from of the North Struts and are fastened using the same bolt/'nut pair that connects Stiffeners East-West. The length and location of the slots on the Covers accommodate structures with varying geometries.

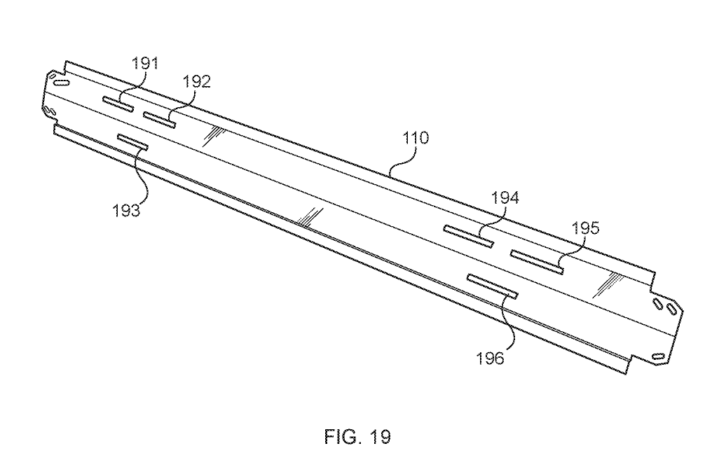

The cover is shown in greater detail in FIG. 19. To increase the range of geometries without having very long slots, which would weaken the component, the cover 110 is symmetric about a horizontal plane (except tier the slots) and can be rotated 180 degrees to engage different slots. The slots 191-196 are short and staggered. With two sets of staggered short slots 191-196 it is possible to accommodate a wide continuous range of variations in rail geometries.

In a preferred embodiment, the rails sit on TPE (thermoplastic elastomer) feet 141, 142, 143 that offer a soft interface with the roof, protecting it from abrasion, as shown in FIG. 14. Since both the rails and the feet are extrusions they can engage at any point along the rail, and feet can be added as needed to reduce load concentration. In addition, the shape of the feet is such that they can be stacked, allowing for an even interface on an uneven roof.

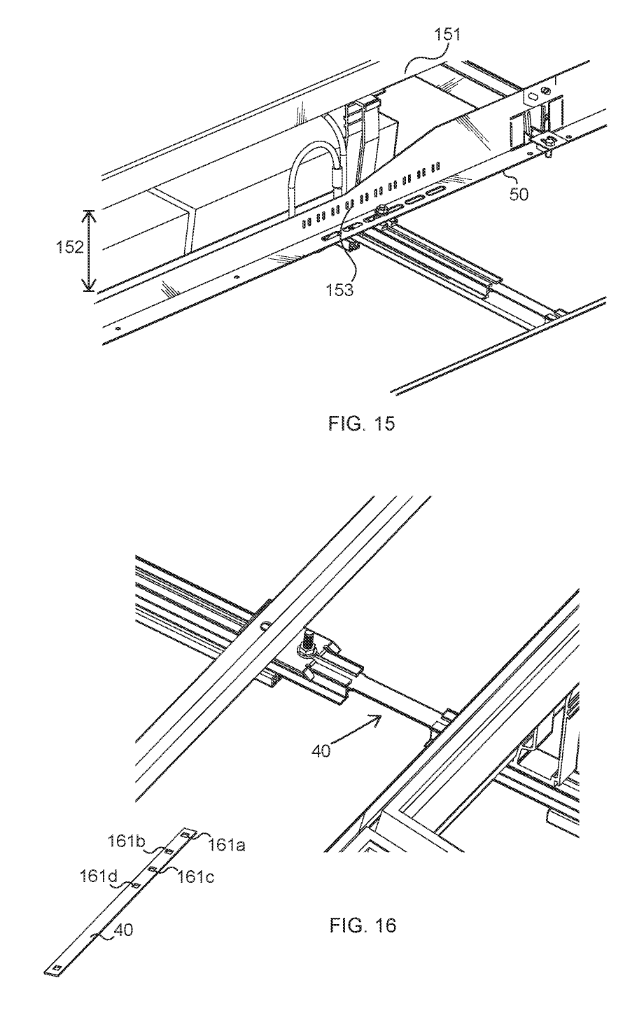

According to a preferred embodiment of the present invention, the Stiffener 50 has a number of features to facilitate wire routing and retention. This is illustrated in FIG. 15. The opening 152 between the Stiffener 50 and the photovoltaic module 151 to makes access to the wiring easy for installation and maintenance personnel. There are also holes 153 on the Stiffener 50 that allow cable ties to retain a loop of wire.

According to a preferred embodiment of the present invention, the rail link 40 has multiple holes 161a-161d for the North Strut bolt which allows the system to be configured with variable row spacing, as shown in FIG. 16. This variation allows for row spacing to conform to various latitudes, resulting in higher density of solar modules at lower latitudes.

FIGS. 17 and 18 illustrate the cross beams and struts in greater detail. Specifically, the cross beams 30, 31 are anchored to the rail via an extruded “track” 170, 171 that allows either the strut 302 on the North side or a clip 172 on the South side to fasten the cross beam to the rail. In addition, the “hook” feature 715 of the strut 302 is shown in great detail in FIG. 18. A photovoltaic panel mounting frame is attached to the strut 302 by the hook 715. The hook 175 secures to one of the mounting holes in a photovoltaic panel, thereby securing the panel to the mounting assembly along one edge.

According to one embodiment of the present invention, a modular photovoltaic panel mounting system utilizes an assembly Jig comprising a photovoltaic panel mounting frame, first and second North rail locators attached to a first side of the photovoltaic panel mounting frame, and first and second South rail locators attached to a second si de of the photovoltaic panel mounting frame, the second side opposite the first side.

The mounting system further comprises a first rail positioned at the first North rail locator and the first South rail locator, a second rail positioned at the second North rail and the second South rail locator, wherein the second rail is located parallel to the first rail, a first cross beam attached perpendicular to the first and second rails, a second cross beam attached perpendicular to the first and second rails, and parallel to the first cross beam, a first strut clamp attached to the first rail, and a second strut clamp attached to the second rail, wherein the assembly Jig facilitates the location and alignment of the first and second rails, the first and second cross beams, and first and second struts.

A method according to the present invention includes a method of constructing an assembly Jig comprising the steps of placing a mounting frame of a photovoltaic panel to be mounted in a mounting location, attaching first and second North rail locators to mounting holes on a first side of the photovoltaic panel frame, and attaching first and second South rail locators to mounting holes on a second side of the photovoltaic panel frame, the mounting frame, and rail locators comprising an assembly Jig.

The Jig is then used to construct multiple Precision-Modular assemblies, identically configured, the construction steps comprising positioning a first rail in the first North and first South rail locators, positioning a second rail in the second North and second South rail locators, positioning a first cross beam in the first and second North rail locators, perpendicular to the first and second rails, positioning a second cross beam in the first and second North rail locators, the second cross beam parallel to the first cross beam, and perpendicular to the first and second rails, positioning a first North strut on the first rail and engaging the first cross beam, positioning a second North strut on the second rail and engaging the first cross beam, attaching the second cross beam to the first and second rails, attaching the first cross beam and the first North strut to the first rail, and attaching the first cross beam and the second North strut to the second rail.

Once the structure is assembled, the mounting structure is removed from the assembly Jig. This process may be repeated to produce as many Precision-Modular assemblies as required to build a particular array.

As the Precision-Modular assemblies are built, they can be laid out in any two-dimensional array format required, interlocking mechanically in both directions. In the North-South direction a rail link extending from the North end of an assembly engages the South end of a next assembly, inserting into the rail track and registering on the tabs of the rail link. In the Fast-West direction, a Stiffener of one assembly fastens onto a Stiffener of a next assembly with two bolt-nut pairs. Multiple fastening locations may be available on the Stiffener to accommodate more than one possible spacing between assemblies.

Ballast blocks may be placed on the array, and the blocks are supported between the two cross beams of each assembly.

Finally, the photovoltaic panels are mounted onto the array in two steps. First, the module mounting clips are attached to both holes on a first side of each photovoltaic module. Then the modules are mounted to each Precision-Modular assembly in the array, fastened on the South side via the module mounting clips, and engaging on the North side hooks on a module flange on both North struts. Once all the modules are mounted and fastened, the system is mechanically complete.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein.

1-19. (canceled)

20. A method of constructing a modular photovoltaic mounting system, the method comprising the steps of:
constructing an assembly Jig, comprising the steps of:
placing a mounting frame of a photovoltaic panel to be mounted in a mounting location;
attaching first and second North rail locators to mounting holes on a first side of the photovoltaic panel frame; and
attaching first and second South rail locators to mounting holes on a second side of the photovoltaic panel frame, the mounting frame, and rail locators comprising an assembly Jig;
positioning a first rail in the first North and first South rail locators of the assembly Jig;
positioning a second rail in the second North and second South rail locators of the assembly Jig;
positioning a first cross beam in the first and second North rail locators, perpendicular to the first and second rails;
positioning a second cross beam in the first and second North rail locators, the second cross beam parallel to the first cross beam, and perpendicular to the first and second rails;
positioning a first North strut on the first rail and engaging the first cross beam;
positioning a second North strut on the second rail and engaging the first cross beam;
attaching the second cross beam to the first and second rails;
attaching the first cross beam and the first North strut to the first rail; and
attaching the first cross beam and the second North strut to the second rail.

21. The method of claim 20, further comprising:
attaching a Stiffener to the first and second rails and the first and second struts.

22. The method of claim 21, further comprising:
removing a completed photovoltaic mounting structure comprising the rails, cross beams, struts and Stiffener from the assembly Jig, the assembly Jig comprising the photovoltaic panel mounting frame, first and second North rail locators, and first and second South rail locators.

23. The method of claim 22, further comprising repeating the construction steps for a plurality of photovoltaic panel mounting structures.

24. The method of claim 22, further comprising attaching a photovoltaic panel to the first and second rails, and the first and second North struts.

25. A method of constructing an assembly Jig, the method comprising:
placing a mounting frame of a photovoltaic panel to be mounted in a mounting location;
attaching first and second North rail locators to mounting holes on a first side of the photovoltaic panel frame; and
attaching first and second South rail locators to mounting holes on a second side of the photovoltaic panel frame, the mounting frame, and rail locators comprising an assembly Jig.

26-28. (canceled)
